(19) United States
(12) Patent Application Publication
(10) Pub. No.: US 2005/0072815 A1
(43) Pub. Date: Apr. 7, 2005

(54) Apparatus for dispensing precise amounts of a non-compressible fluid

(76) Inventors: Dennis Carew, Burlington, MA (US); Cyriac Devasia, Nashua, NH (US); Bruno Miquel, Newton, MA (US)

Correspondence Address: STOEL RIVES LLP, 900 SW FIFTH AVENUE, SUITE 2600, PORTLAND, OR, 97204, US

(21) Appl. No.: 10/606,570

(22) Filed: Jun. 26, 2003

Related U.S. Application Data
(60) Provisional application No. 60/392,612, filed on Jun. 28, 2002.

(51) Int. Cl. B67D 3/00

(52) U.S. Cl. 222/504

(57) ABSTRACT

A dispensing apparatus has a motor drive that moves an output member along an axis in a first chamber. A shuttle valve controls flow between a first chamber and either a reservoir of material or an output port. Extending the output member discharges precise volumes of material through an output port. Retracting the output member fills the first chamber.

### BACKGROUND OF THE INVENTION

1. Field of the Invention

This invention generally relates to dispensing apparatus and more particularly to apparatus capable of dispensing precise volumes of a non-compressible fluid.

2. Description of Related Art

Variable volume dispensers of non-compressible fluids have a variety of applications and implementations, each of which imposes accuracy requirements that vary from one application to another. Manufacturing involving the placement of electronic components represents one such application. In this application the miniaturization of electronic assemblies has produced a need for dispensing apparatus with tight controls for a variety of non-compressible materials of different viscosities, such as epoxies and paste. For example, the actual volume of material that is dispensed must equal a target or set point amount. However, it should be possible to vary the set point amount for different operations. Moreover, the correspondence between the actual and set point volumes must be maintained using materials of different viscosity.

Often such apparatus dispenses materials in a non-continuous fashion. That is, automated apparatus may dispense a quantity of material at one site, stop dispensing as the apparatus traverses to another site and then resume dispensing at that other site. It is mandatory that no material exits the dispensing apparatus during such a traverse.

Over the years positive displacement pumping systems have been adapted for such applications because positive displacement pumps hade the potential of meeting the foregoing requirements in the electronics field. For example, U.S. Pat. No. 3,666,147 (1972) to Shiraki et al. disclose an apparatus for feeding viscous materials. Dispensing apparatus in the form of a feeder comprises two piston-cylinder units combined integrally in a cross shape connected to a storage tank with a viscous material. A drive moves the two pistons within their respective cylinders to suck the viscous material into one of the cylinders and to discharge the material from the other of the cylinders.

U.S. Pat. No. 4,055,281 (1977) to Rosen et al. discloses a filling unit with a pneumatically operated spool valve system. A solenoid valve is controlled by the main shaft of a filling machine and selectably supplies air under pressure to a respective end of a pneumatically operated piston-cylinder unit in the spool valve assembly. The spool valve assembly then selectively opens and closes a pump space with respect to a reservoir for the product to be filled while simultaneously closing and opening the pump space with respect to a discharge nozzle.

U.S. Pat. No. 4,648,533 (1987) to Rasmussen discloses a fluid dispensing system with a positively actuated inlet valve and a small diameter, long-stroke pumping piston that stops at each end of its stroke. The inlet valve and piston enable the system to dispense metered volumes of a fluid repetitively at better than 1/10 of 1% accuracy. A calibration mechanism and detachable dispensing head allow for the rapid disassembly, cleaning and reassembly of the system.

U.S. Pat. No. 6,360,920 (2002) to Corominas discloses a volumetric doser apparatus for a pasty material. The apparatus includes a dosing chamber which is internally provided with a piston displaceable freely by means of pasty material introduced through a first extremity of the chamber such that the piston moves from a first position to a second position. The piston is then actuated by means of a pressure fluid introduced through a second extremity to return to the first position, thereby displacing a volume through the extremity which is associated with the sealed closing means to an opening of a housing. The housing contains a valve body that can be moved inside a housing thereby communicating an inlet with said chamber and alternatively communicating said chamber with an outlet conduit having an emptying piston.

Such systems have been popular and have been adapted for a wide variety of applications. However, dependence of the relative displacement of two members in a sealed relationship introduces problems. Consequently experience has shown that such systems may operate with materials having only a limited range of viscosities. It has also been found that such systems may be difficult to clean and difficult to set up for different materials. Consequently the process for changing any materials to be dispensed can not occur rapidly and efficiently. What is needed is a dispensing apparatus that is capable of displacing predictable volumes of material having a wide range of viscosities on a repeatable basis. What is also needed is a dispensing apparatus that has the foregoing features, that has reasonable manufacturing costs and that is easy to implement and use.

### SUMMARY

Therefore it is an object of this invention to provide an apparatus that is capable of dispensing predictable volumes of material on a repeatable basis.

Another object of this invention to provide an apparatus that is capable of dispensing predictable volumes of material utilizing, at different times, materials having a wide range of viscosities.

Yet another object of this invention to provide an apparatus that is capable of dispensing predictable volumes of material on a repeatable basis that is easy to use and facilitates use with different materials.

Still another object of this invention to provide an apparatus that is capable of dispensing predictable volumes of material on a repeatable basis that is reasonable to manufacture and to operate.

In accordance with one aspect of this invention, a dispensing apparatus includes a pump body with an output member for undergoing reciprocal motion over a defined range along the piston axis. A pump manifold attaches to the pump body and includes input and output ports, a first chamber extending along the pump axis for receiving the output member and a second chamber intersecting the first chamber. The first and second chambers collectively define a closed reservoir between the input and output ports. The output member moves in a non-sealing relationship within the first chamber. A shuttle valve in the second chamber translates between first and second positions. In a first position the shuttle valve establishes a flow path between the input port and the first chamber. In a second position the shuttle valve establishes a flow path between the first chamber and the output port. First and second actuators move the shuttle valve between the first and second positions respectively. Displacing the output member in a dispensing direction with the dispensing actuator having moved the shuttle to the second position causes a volume of material to be dispensed. The volume corresponds to the product of the area of the output member and the distance the output member travels.

### BRIEF DESCRIPTION OF THE DRAWINGS

The appended claims particularly point out and distinctly claim the subject matter of this invention. The various objects, advantages and novel features of this invention will be more fully apparent from a reading of the following detailed description in conjunction with the accompanying drawings in which like reference numerals refer to like parts, and in which:

FIG. 1 is a pictorial representation of dispensing apparatus constructed in accordance with this invention;

FIG. 2 is a view, partially in cross-section of a dispenser constructed in accordance with this invention;

FIG. 3 is an enlarged view of a shuttle valve shown in FIG. 2; and

FIGS. 4A through 4D are drawings useful in understanding the operation of this invention.

### DESCRIPTION OF ILLUSTRATIVE EMBODIMENTS

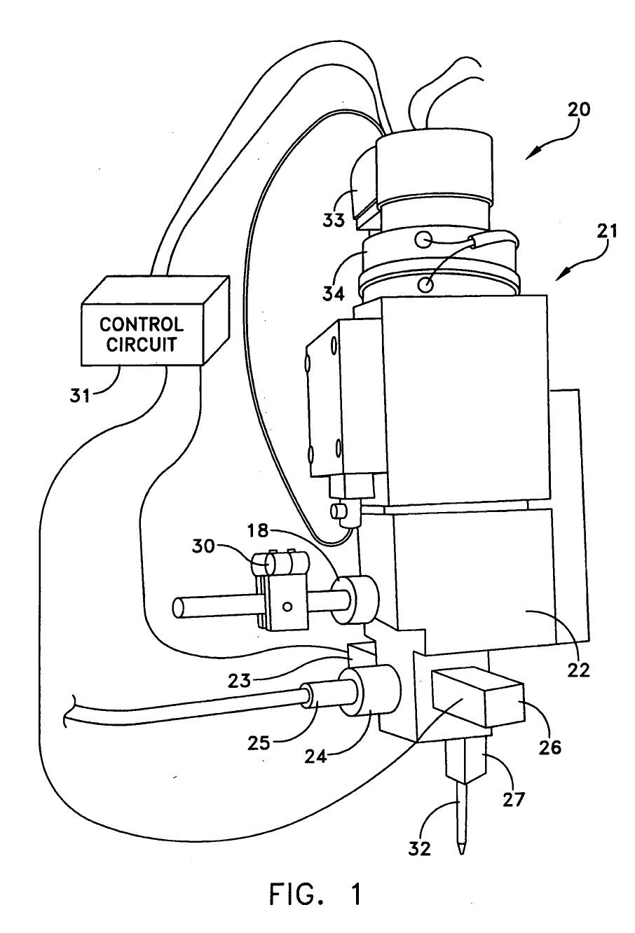

FIG. 1 particularly depicts the major components of a dispensing apparatus 20 that includes a pump assembly 21 that carries a pump manifold assembly 22. A fill actuator 23 positions an internal shuttle valve, described later, for controlling the flow of material into an input port 24, such as a Leur lock connector, from a reservoir represented by a tube. A dispensing actuator 26 likewise controls the transfer of material to an output port 27. In addition the dispensing apparatus 20 has a purge port 28 with a purge valve 30. A control circuit 31 energizes a drive motor in the pump assembly 21 and the actuators 23 and 26 for dispensing precise amounts of material through a dispenser port, such as a dispensing needle 32.

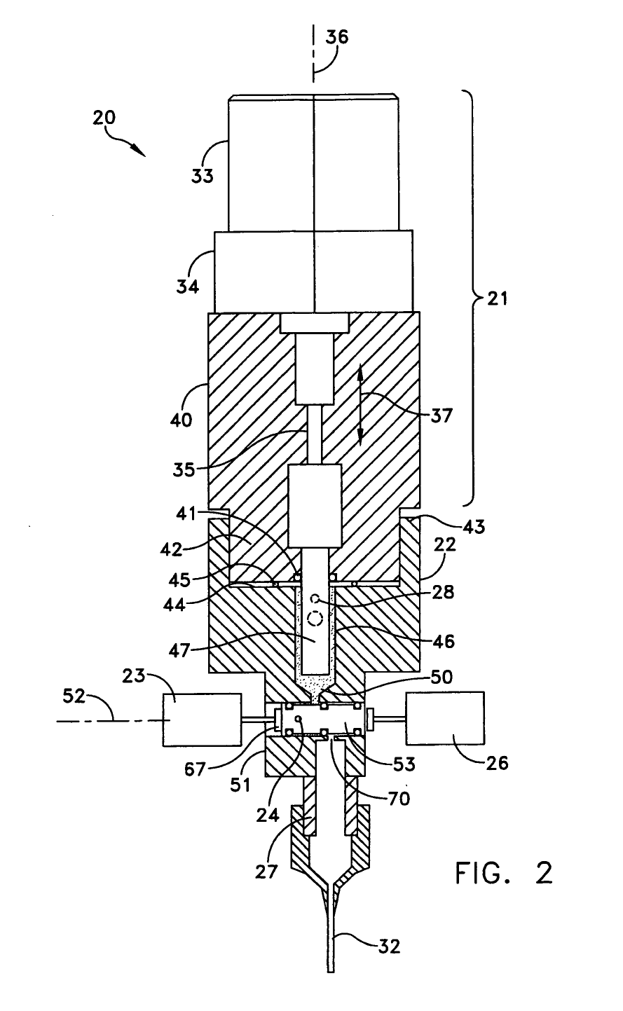

Referring to FIGS. 1 and 2, the pump assembly 21 comprises a drive motor located in a housing 33. The drive motor may be a bi-directional stepping motor with a precise positioning control or equivalent device. A housing 34 contains a rotational-to-reciprocating drive transmission such as a travelling-nut converter. Consequently when the motor is energized in one direction or another, an output member 35 will reciprocate along a vertical axis 36 as represented by an arrow 37. One end of the output member 35 extends from a housing 40 through a dynamic sliding seal 42. In addition a reduced diameter extension 42 on the housing 40 fits in a collar 43 formed in the pump manifold 22 and sits on a base 44 against a sealing O-ring 45.

The pump manifold 22 defines a first chamber 46 that extends from the base 44 at the bottom of the collar 43. An output member 47 extends from the shaft 35 through the dynamic slip seal 41 and into the first chamber 46.

At the bottom of the chamber 46 a passage 50 communicates with a second chamber 51. In this particular embodiment the second chamber 51 lies along an axis 52 that intersects the axis 37 at right angles.

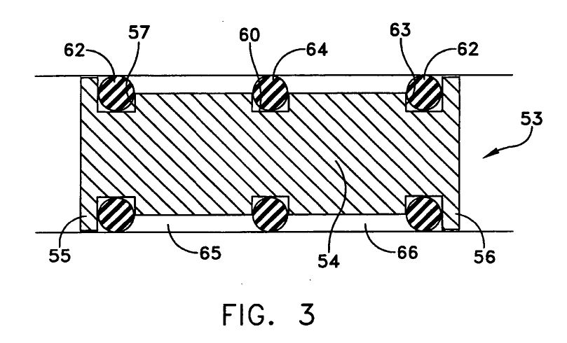

A shuttle valve 53 slides in the second chamber 51. As particularly shown in FIGS. 2 and 3, the shuttle valve 53 comprises a body portion 54 with opposite end walls 55 and 56 sized to slide easily along the axis 52 in the second chamber 51. The body 54 additionally includes first and second end circumferential channels 57 and 60 proximate the end plates 55 and 56, respectively. An intermediate channel 61, generally at the center of the shuttle valve 53, constitutes a third circumferential channel. Each of the channels 57, 60 and 61 carries an O-ring, designated as O-rings 62, 63 and 64, respectively. The O-rings are sized to provide absolute seals against the surfaces of the chamber 51 as the shuttle valve 53 slides within the second chamber 51. Undercut peripheral portions 65 and 66 in the body portion 54 form annular channels or passages between the O-rings 62, 63 and 64.

When the shuttle valve 53 shifts toward the actuator 26 as shown in FIG. 2, the channel 65 spans the input port 24 and the passage 50. This establishes a path from the input port 24 to the first chamber 46. However, the O-ring 64 blocks a path from the first chamber 46 through an output passage to the output port 27. This is a fill orientation of the shuttle valve 53. When the shuttle valve 53 shifts toward the actuator 23, the channel 66 spans the passage 50 and the output passage 70 while the O-ring seal 62 and 64 isolate the chamber 46 from the input port 24. Thus there is a passage from the first chamber 46 through the channels 66, the passage 70 and the output port 27 to the dispensing needle 32. This is the dispensing orientation of the shuttle valve 53.

When a non-compressible fluid fills the chambers 46 and 51 and related passages, any attempt to extend or retract the output member 47 changes the volume of the output member 47 within the first chamber 46. During a dispensing cycle, when the shuttle valve 53 is moved toward the actuator 23, moving the output member 47 into the first chamber 46 increases the volume occupied by the output member 47. As the material is non-compressible, a corresponding volume of material must be dispersed from the dispensing needle 32. Likewise when the shuttle valve 53 is in the fill position as shown in FIG. 2, retracting the output member 47 reduces the volume it occupies and causes material to move into the first chamber from the input port 24.

With this configuration, there is no requirement for a seal between the output member 47 and the portion of the pump manifold 22 that defines the first chamber. In fact, the correspondence between the actual amount of material dispensed against the set point is dependent solely on the ability to control the volume increase of the output member 47 within the chamber 46. There are two requirements. Firs, the output member 47 must be made of a material with certain properties. The material should be non-reactive with the non-compressible fluid, such as an epoxy. The material should be stable dimensionally over a typical operating temperature range. The material should be easily be machined to precision dimensions. It has been found that various ceramic materials have all these characteristics so in a preferred embodiment the output member 47 is machined from ceramic.

If the output member 47 is stable dimensionally, then the precision of the dispensing operation is dependent upon the controls for the motor that displaces the output member 47. This is the second requirement. However, such control systems are readily available. Consequently, in this dispensing apparatus, the amount of material that is actually dispensed depends entirely on the increase of the volume of the output member 47, the quantity that is dispensed is entirely independent of the viscosity of the material.

It is important that the chambers, such as the first and second chambers 46 and 47 be completely filled with material to assure the correspondence between a change in the volume of the output member 47 and the amount of displaced material. Thus, when a new material is to be used, the chambers must be filled with that material and any air must be removed. Referring particularly to FIG. 1, this process occurs when the purge valve 30 opens, the shuttle valve 53 is in the fill orientation shown in FIG. 2 and the output member is fully retracted. This is a normal position for the control established by the control circuit 31. With this position of the shuttle valve 53, a material reservoir can be pressurized to force material through the input port 24 to fill the first passage 46 and to fill that portion of the second passage 51 that is coextensive with the channel 65. During this process any air within the first chamber 46, passage 50 and channel 65 exits through the purge port 28 with its open purge valve 30. When the chamber fills, material will bleed from the purge port 28 through the purge valve 30. When this occurs, the purge valve 30 can be closed. The first chamber 46, passage 50 and channel 66 and input port 24 then contain material with no entrapped air. At this point pressurization of the material reservoir can be terminated.

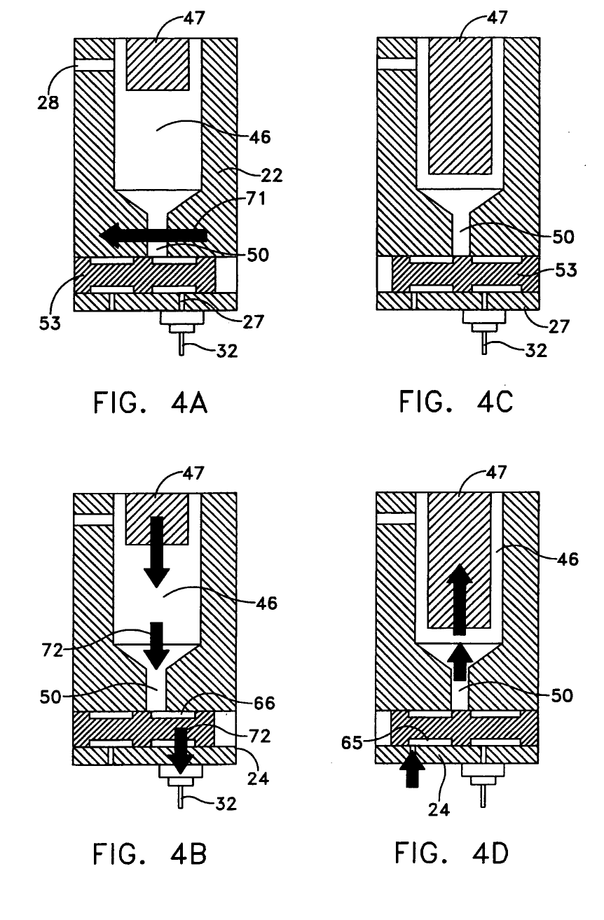

FIG. 4A depicts the operation that initiates a dispensing operation assuming that all the chambers have been filled. The output member 47 is fully retracted. The purge port 28 is closed. The actuator 26 drives the shuttle valve 53 to a dispensing position as shown by an arrow 71 so the passage 50 is in communication with the output port 27 and dispensing needle 32.

FIG. 4B depicts the beginning of a downward motion of the member 47. With this downward motion, the volume of the output member 47 within the first chamber 46 increases and drives material through the passage 50, chamber 66, the output port 24 and the dispensing needle 32 as represented by arrow 72.

After the output member 47 reaches a maximum extension as shown in FIG. 4C, the actuator 23 moves the shuttle valve 53 toward a fill position and terminates any flow of material from the passage 50 through the outlet port 27 and the dispensing needle 32. In this position the shuttle valve 53 is in a fill position. Retracting the output member 47 produces a partial vacuum within the first chamber 46 so material enters by way of the input port 24, the channel 65 and the passage 50. When the output member 47 reaches an upper position a next dispensing operation can occur.

In a preferred embodiment the control 31 in FIG. 1 normally energizes the actuator 23 and deenergizes the actuator 26 so that the shuttle valve 53 is in the fill position except during an actual dispensing operation. After a dispensing operation occurs moving the shuttle valve 53 to the fill position minimizes the material that is in the channel 66, the output port 27 and needle 32. In this case a differential pressure tends to negate any tendency of material to drip from the dispensing needle 32.

Another advantage of this invention is the ease with which materials can be changed. When materials need to be changed, it is generally necessary to clean all the surfaces of the pumping apparatus that contact that material. In accordance with this invention, a cleaning operation commences when the control 31 retracts both the actuators 23 and 26 typically leaving the shuttle valve 53 in the fill position shown in FIG. 2. Next the pump assembly 21 and pump manifold 22 are removed from the position shown in FIG. 2 with respect to the actuators 23 and 26 and then separated typically by removing some fasteners that hold the pump assembly 21 and pump manifold 22 together. Thereafter the shuttle valve 53 is readily removed from the pump manifold 22 along with the dispensing needle and purge valve 30. All these elements can then be soaked in a solvent for cleaning and then readily reassembled. In addition the cleaning operation will include wiping any exposed portion of the output member 47 extending below the dynamic sealing ring 41. The dynamic sealing ring will have cleaned any material on the element 47 that extends above the seal 41.

Therefore in accordance with this invention a dispensing apparatus constructed in accordance with this invention dispenses predictable volumes of material on a repeatable basis because controlling the distance the output member 47 extends into the first chamber 46 accurately controls the amount of material ejected from the dispensing needle 32. Further this provides accurate dispensing for materials having a wide range viscosities. As will be apparent the components of the dispensing apparatus, particularly the pump manifold 22 and shuttle valve 53 are readily manufactured particularly as tolerances with respect to the relative sizes of the first chamber 46 and output member 47 are not important, so manufacturing costs are minimized.

This invention has been disclosed in terms of a dispensing apparatus with a specific structure. Different assemblies could be substituted for the motor drive 33 and transmission 34. Different couplings between the drive transmission 34 and an output member 47 could be substituted. It is assumed that the output member 47 has a cylindrical shape; other shapes are possible. The dispensing apparatus has been shown with a specific relationship between an input port 24, an output port 27 and a purge port 28. Other relationships could be established. Consequently these and other modifications can be made to the disclosed apparatus without departing from the invention. It is the intent of the appended claims to cover all such variations and modifications as come within the true spirit and scope of this invention.

1. A dispensing pump comprising:
A) a pump body including an output member for undergoing reciprocal motion over a predefined range and along a piston axis,
B) a pump manifold attached to said pump body and including an input port, an output port, first means for defining a first chamber extending along the pump axis for receiving said output member and second means defining a second chamber intersecting said first chamber for providing a path between said input and output ports wherein said first and second chambers define a closed reservoir between said input and output ports and wherein said output member is in a non-sealing relationship with said first chamber defining means,
C) a shuttle valve disposed in said second chamber for translation therein along a shuttle valve axis between a first position for reestablishing a flow path between said input port and said first chamber and a second position for establishing a flow path between said first chamber and said output port,
D) fill and dispense actuators for moving said shuttle valve to said first and second positions respectively.
